(19) United States
(12) Patent Application Publication
(10) Pub. No.: US 2007/0197228 A1
(43) Pub. Date: Aug. 23, 2007

(54) System and method for improved mobile connectivity via a content management platform

(76) Inventors: Faith McGary, Bethlehem, PA (US); Ian Bacon, Manassas, VA (US)

Correspondence Address: SOFER & HAROUN LLP., 317 MADISON AVENUE, SUITE 910, NEW YORK, NY, 10017, US

(21) Appl. No.: 11/699,922

(22) Filed: Jan. 30, 2007

Related U.S. Application Data
(60) Provisional application No. 60/763,947, filed on Jan. 31, 2006.
(60) Provisional application No. 60/763,951, filed on Jan. 31, 2006.

(51) Int. Cl. H04Q 7/20

(52) U.S. Cl. 455/445

(57) ABSTRACT

A platform for providing mobile services maintains a network module for communicating with at least one mobile network and an MVNO module for communication with at least two MVNO service providers. When a user contacts the platform and receives mobile services including MVNO services from at least two different MVNO service providers, the platform is configured to store a profile generated by the user for storing events where the occurrence of the event causes the platform to switch the user's MVNO service provider from a first MVNO service provider to a second MVNO service provider.

### RELATED APPLICATION

The present invention is related to and claims the benefit of priority from Provisional Patent Application No. 60/763,947, and Provisional Patent Application No. 60/763,951, both filed on Jan. 31, 2006, and both of which are incorporated herein by reference.

### FIELD OF THE INVENTION

The present invention is related to mobile content providers. More particularly, the present invention relates to a platform for improved connectivity to mobile content providers.

### BACKGROUND

Currently, cell phone users typically have contracts with network operators (cellular providers) for handling their cellular/wireless communications. Traditionally, network operators provide users with standard wireless communication pathways, with contracts being set in terms of airtime minutes/limits. However, as the processing power of wireless devices, such as mobile phones, PDAs, wireless lap top computers, etc . . . , increases so as to be able to utilize enhanced content and programming in addition to simple voice communications, users are expecting to receive ever higher levels of and customized content and programming. In prior art arrangements, such content is being provided by the network operators as secondary features, but as content expectations expand, network operators will not be able to keep up with the widely varying demands for ever narrowing scopes of desired content, such as highly localized content, and/or genre specific content.

One such method for addressing these needs is the advent of MVNOs (Mobile Virtual Network Operators). MVNOs, are providers of mobile services to users that do not operate their own network/wireless communication equipment. Rather, MVNOs typically contract with a larger network provider to cover the user's air time and then focus more acutely on content development/delivery and content interfaces for the user. As such, MVNOs are better able to tailor enhanced content to a particular community of users than traditional network providers, without the need for setting up an entire wireless network infrastructure.

Unfortunately, such an arrangement still requires that MVNOs maintain direct contracts with network providers that adds a costly level of back-end operations. Furthermore, MVNOs need to manage the complex billing and record collection necessary to manage their user accounts. This not only makes the start up costs for an MVNO high, making profit margins thin, but it also detracts from their focus of providing enhanced and directed mobile content to their users.

Furthermore, it is noted that the current arrangement for MVNOs is still limiting with respect to targeted content. With the current implementation of MVNOs a user may sign a contract with one MVNO for mobile services (content+wireless communication) but they are limited to receiving only the content provided by their MVNO and to the network coverage offered by network operator that their MVNO uses. For example, a user purchasing an agreement with an MVNO receives a phone that is configured to receive content only from that MVNO and is operated via a wireless network as set forth by the agreement between the MVNO and the wireless provider they use. As such, users are limited to only one MVNO provider of enhanced content and are tied to the particular network provider that the MVNO uses, which may not have adequate or acceptable capacity in the geographic area where the user primarily employs their mobile device.

### OBJECTS AND SUMMARY

The present invention looks to overcome the drawbacks associated with the prior art and to provide users with a single platform for receiving enhanced/target content from a plurality of MVNO providers, with the ability to receive a first enhanced content from a first MVNO provider and second enhanced content from a second MVNO provider. Utilizing newer generation mobile devices that can quickly change from one MVNO to a second MVNO, as well as from a first network operator to a second operator a user may advantageously simply select various desired mobile contents from a plurality of providers, while interfacing with a single content management platform. Furthermore, the present invention looks to simultaneously overcome the drawbacks associated with MVNO startup costs by providing a platform for MVNOs to be offered directly to users, while handling the operations with the network operators for providing the user's wireless/cellular airtime.

To this end, the present invention provides for a platform for providing mobile services maintains a network module for communicating with at least one mobile network and an MVNO module for communication with at least two MVNO service providers. When a user contacts the platform and receives mobile services including MVNO services from at least two different MVNO service providers, the platform is configured to store a profile generated by the user for storing events where the occurrence of the event causes the platform to switch the user's MVNO service provider from a first MVNO service provider to a second MVNO service provider. Furthermore, the present invention provides for a means for switching the user's device fro operating on a first mobile network to a second mobile network.

### BRIEF DESCRIPTION OF THE DRAWINGS

The present invention can be best understood through the following description and accompanying drawings, wherein:

FIG. 1 illustrates a content management platform, in accordance with one embodiment of the present invention;

FIG. 2 illustrates the content management platform from FIGS. 1 in an alternative arrangement, in accordance with one embodiment of the present invention;

FIG. 3 illustrates a user profile, in accordance with one embodiment of the present invention;

FIG. 4 is a flowchart of the operations for the content management platform from FIG. 1, in accordance with one embodiment of the present invention;

FIG. 5 illustrates the content management platform from FIGS. 1 in an alternative arrangement, in accordance with one embodiment of the present invention; and

FIG. 6 is a flowchart of the operations for the content management platform from FIG. 4, in accordance with one embodiment of the present invention.

### DETAILED DESCRIPTION

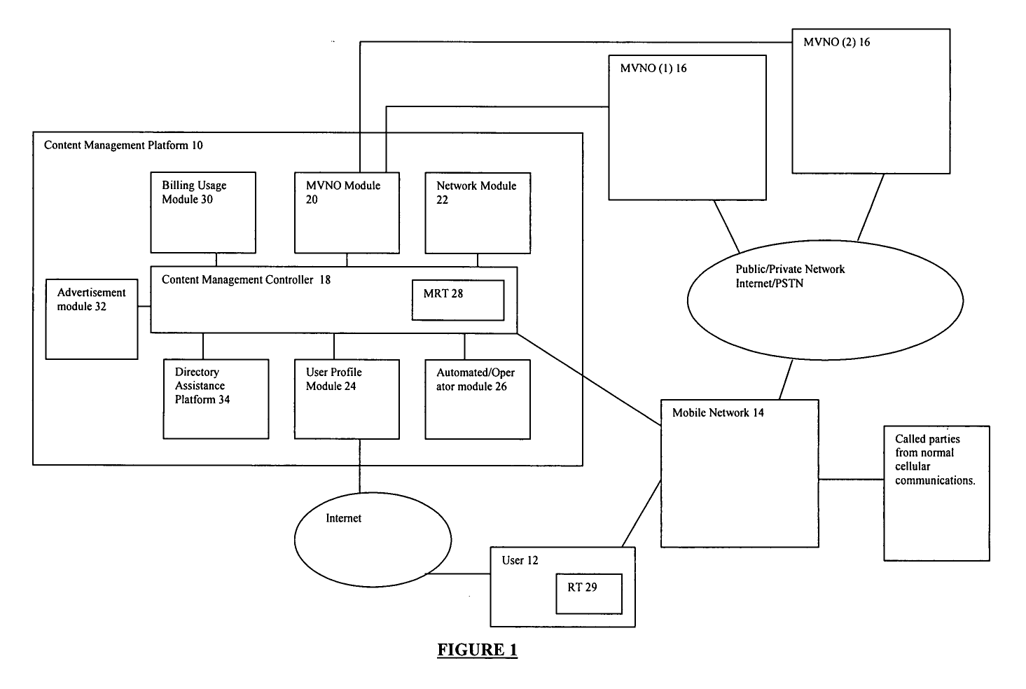

In one embodiment of the present invention, FIG. 1 illustrates a content management platform 10 for providing enhanced mobile services to a mobile device 12 of a user via a mobile network 14 and any one of a plurality of MVNOs (Mobile Virtual Network Operators) 16. Content management platform 10 is shown an independent entity apart from mobile network 14 with a number of internal modules. However, it is understood that content management platform 10 may be employed within mobile network 14 directly. For the purposes of illustrating the salient features of the present invention content management platform 10 is discussed through as being an independent platform.

Mobile device 12 refers broadly to any device that employs any from of mobile connectivity. The prototypical example used throughout to discuss the features of the present invention is a mobile telephone device 12. However, it is understood that the features of the present invention are equally applicable to other mobile capable devices including but not limited to PDAs, Lap top computers, and are likewise equally applicable to non-cellular wireless connections such as VoIP/WiFi WiMax connections.

As discussed in the background section, mobile networks 14 are traditional mobile/cellular providers that employ mobile architecture including cellular towers, WiFi/WiMax hot spot equipment, PSTN connectivity, Internet connectivity and the related switching and call/internet session management capabilities.

In one embodiment of the present invention MVNOs 16 refer to any content developer/provider directed primarily to providing content to mobile device 12. Typical MVNOs may provide any number of services to device 12 including, but not limited to, downloadable ring tones, web searching services, movie/entertainment content, sports content, weather content, games, executable programming, voice mail/business support services, geographically localized content, etc . . . It is understood that the MVNO not only provides such services to device 12, but also provides the necessary application/code and navigation skins for operating such functions.

Obviously the list of possible MVNO 16 services is too exhaustive to list in full. However, it is understood that MVNOs 16 in the context of the present invention may be any provider of any content designed primarily to be provided to a mobile user via device 12. MVNOs 16 are typically configured to supply such content/services via servers, which through a public/private network such as the internet, are connected to networks 14 and in turn devices 12.

Such an arrangement as shown in FIG. 1 is configured to allow a user of mobile device 12 to set up a profile with content management platform 10 so that the user may employ the services of two or more MVNOs 16 on a single mobile device, the operation of which is managed by platform 10 with the mobile connectivity being handled by mobile network 14. The following is detailed discussion of the modules within platform 10 for achieving this connectivity arrangement. It is understood that the following discussion is in no way intended to limit the number of modules that platform 10 may employ, but rather is intended to describe one exemplary embodiment of such a platform.

Furthermore, the arrangement discussed herein is configured to allow a central content management platform 10 handle the wireless connectivity to the users of devices 12 via bulk/user contracts with mobile network 14 so that MVNOs 16 do not have to directly contract with networks 14. Instead, MVNOs 16 need only set up connectivity through the control of content management platform 10, that in turns handles the mobile airtime arrangements with mobile networks 14. Users of mobile device 12 need only sign with content management platform 10 to obtain both wireless connectivity via networks 14 and tailored content from MVNOs 16.

As illustrated in FIG. 1, content management platform 10 includes a number of modules coupled to a central content management controller 18. Controller 18 is configured to allow communications to flow between modules and to interface platform 10 with incoming communications from user's mobile device 12. Furthermore, it is understood that the below described modules may be re-arranged, combined, sub-divided into separate modules based on specific implementations of platform 10, and that the invention is not limited in scope to the arrangement shown in FIG. 1.

In one embodiment of the present invention, an MVNO module 20 is configured to be coupled with one or more MVNOs 16 so as to provide platform 10 with the necessary information for allowing device 12 to connect with MVNOs 16. Each MVNO employs a particular billing arrangement, has particular connectivity arrangements, IP address etc . . . MVNO module 20 provides a means for storing and continuously updating the necessary information for all partner MVNOs 16 that are offered through the assistance of content management platform 10.

The present invention contemplates that a number of disparate MVNOs 16 may sign up with content management platform 10 so that a user who subscribes for mobile services through platform 10 may select from any number of the offered MVNOs 16 to be operated on their mobile device 12. As noted above, these MVNOs 16 need only set up connectivity arrangements and billing arrangements with content management platform 10 who in turn handles all of the direct interactions/transactions with the users of device 12 as well as with the necessary mobile networks 14, the operation of which is discussed in more detail below.

In one embodiment of the present invention, network module 22 within content management platform 10 is configured to store the necessary information for supporting the mobile connectivity of device 12 via mobile network 14. The present invention contemplates that the user of device 12 subscribes for mobile services directly with content management platform 10 that in turn contracts with mobile network 14 for supplying the mobile connectivity to device 12.

Thus, content management platform 10 in addition to contracts and connectivity information required for connecting devices 12 with MVNOs 16, separately maintains contract and connectivity routing information for supporting the actual mobile/cellular connectivity of devices 12 via mobile network 14 in mobile network module 22.

Such a mobile network module 22 may include any necessary information for supporting the identification of devices 12, the necessary routing and connectivity addressing information for allowing the users of device 12 to connect to mobile network 14 and the necessary information for communicating/updating such information with mobile network 14. As noted above, such an arrangement alleviates the need for MVNO 16 to independently contract with wireless network providers to channel their content services to users, that is instead handled by content management platform 10

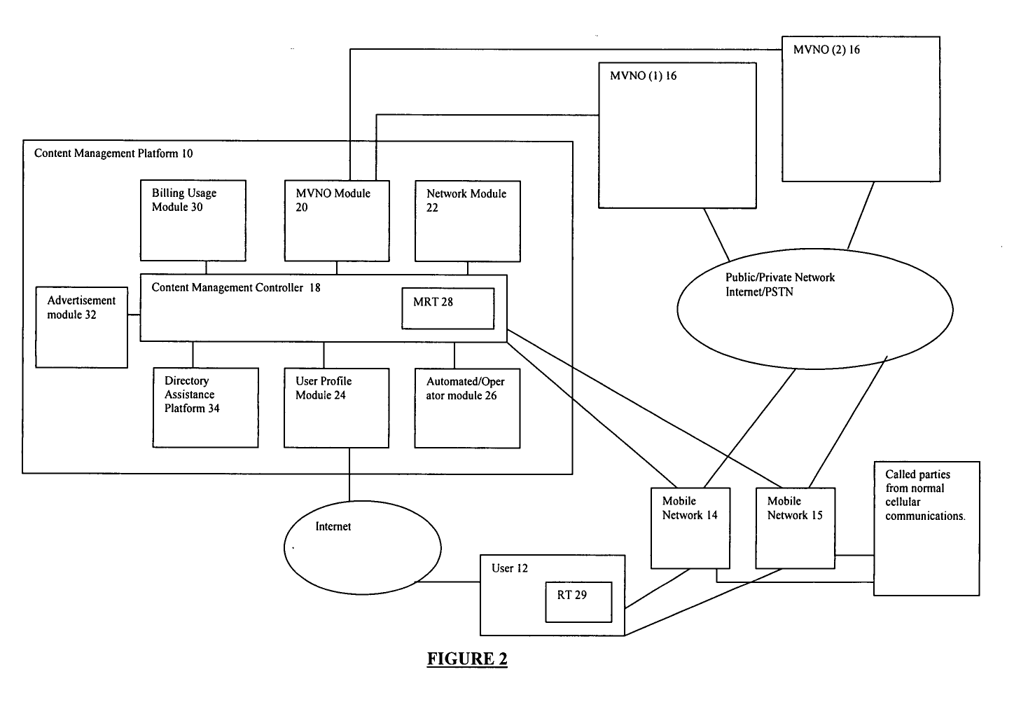

In an alternative embodiment as illustrated in FIG. 2, a second mobile network 15 may be coupled to platform 10 such that platform 10 is not limited to using a single mobile network 14 to support the mobile connectivity of device 12. In such an instance mobile network module 22 may contain connectivity/contract information relating to multiple mobile networks 14, 15 so that the devices 12 of the users may employ the services of content management platform 10 across a wider geographic coverage area.

For example, a user in a first geographic area using platform 10 may employ the services of three MVNOs 16 and maintain wireless connectivity from first mobile network 14 whereas a second user of platform 20 in a separate geographic location may employ the services of the same three MVNOs 16 yet use mobile connectivity through the second mobile network 15.

Furthermore, such an arrangement allows platform 10 to seek the best possible pricing advantages from varying mobile networks 14. For example, even with the same geographic region, the users of platform 10 may use mobile connectivity from a first mobile network 14 at one time of day and a second mobile network 15 at a second time of day. The switch may be based on platform 10 being able to obtain advantageous pricing at different times from different networks 14 and 15. However, such connectivity switching from one mobile network to the next would be seemless to both the user of mobile device 12 (instructions to the device being handled by platform 10) as well as MVNOs 16, who as described above, do not directly interact with the mobile networks.

It is noted that for the purposes of illustration of the remaining features of the invention, the arrangement of a single mobile network 14 is used through the application, although the invention is not limited to such scope.

Thus, by the above arrangement, a user of device 12, may receive cellular services from content management platform 10, whereby platform 10 handles on one end the mobile network 14 connections for user 12 while simultaneously allowing users 12 to select to receive MVNO services from any one of the MVNOs 16 coupled to platform 10 as discussed in more detail.

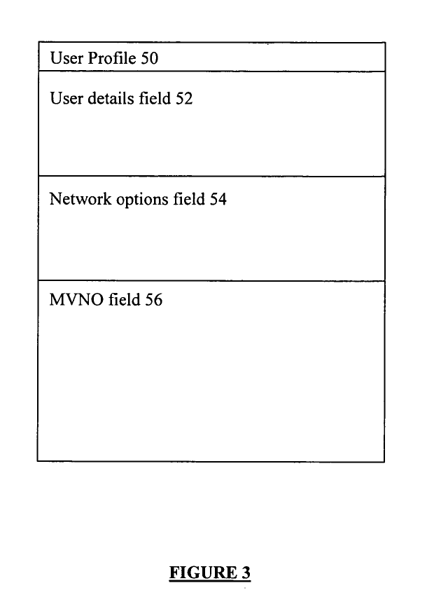

In one embodiment of the present invention, as illustrated in FIG. 1, a user profile module 24 is provided for generating and storing a profile 50 for each device 12 of the user. It is contemplated that when the user of device 12 initially signs for mobile services from content management platform 10, a series of information must be collected from the user of device 12 for generating profile 50 so as to manage their account(s). This profile 50, shown in FIG. 3, may either be updated by a call to platform 10 or directly by a web interface with profile module 24.

Profile 50 maintains a user field 52, a network options/airtime field 54 and an MVNO instructions field 56. User field 52 is simply a list of the name, billing address, telephone contact, e-mail contact, possible pre-payment credit/debit information, and any other pertinent personal information of device 12.

Network options field 54 maintains the basic connectivity arrangements for device 12 and other details necessary for maintaining their wireless airtime. For example, network options field 54 maintains the amount of monthly airtime (or other airtime arrangements), their billing rate etc . . .

MVNO field 56 includes the list of MVNOs 16 that user of device 12 has subscribed to, as well as the associated billing information for using such MVNOs 16. It is contemplated when the user of device 12 registers with content management platform 10 that they initially generate an account and arrange for some general wireless airtime. Then, they are presented with a number of MVNO 16 options such as those discussed above (downloadable ring tones, web searching services, movie/entertainment content, sports content, weather content, games, executable programming, voice mail/business support services, geographically localized content, etc . . . ), each of which has a particular billing rate associated with it. The user may initially select the MVNOs 16 they are interested the list being in turn stored in MVNO field 56 of user profile 50. MVNO field 56 may be updated or changed at the request of the user of device 12 as discussed below.

The above list of fields is not intended to be exhaustive but merely to illustrate some basic fields in profile 50 needed for maintaining the basic connectivity and accounting functions of content management platform 10. Additional fields may be added as necessary based on the specific implementation of content management platform 10 consistent with maintaining the proper functioning of the features described herein.

In one embodiment of the present invention, an automated response operator module 26 is maintained in content management platform 10, configured to support automated/live operator interface communications between the users of device 12 and platform 10. For example, services supported by automated response/live operator module 26 may include, but are not limited to, updating profiles 50 (adding/deleting MVNOs, changing wireless airtime profiles), providing enhanced services to the users of device 12 such as directory assistance as discussed below, and providing help customer service to the users of device 12.

In another embodiment of the present invention, a Master Routing Table (MRT) 28 is contained within controller 18 of content management profile 10. MRT 28 is the component of platform 10 that is responsible for interfacing with profile 50 in user profile module 24, network module 22, and MVNO module 20 so that the correct codes for a particular device 12 are properly arranged so that they receive the necessary wireless connectivity and connectivity to the subscribed MVNOs 16. MRT 28 is configured to initially place this information into a local Routing Table 29 in device 12 of the user when the user signs with platform 10 and then periodically (daily, hourly etc . . . ) updates RT 29 to reflect any changes that are reported from MVNO module 20, network module 22 or user profile module 24. In addition to MRT 28 receiving its routing instructions from profile 50, it is understood that in instances where a user changes MVNos 16 manually by way of automated/live operator module 26, MRT 28 may receive instructions directly from operator module 26.

Such an arrangement allows platform 10 to completely manage device 12, including their MVNO 16 services as well as their mobile connectivity through mobile networks 14, without either MVNOs 16 or network 14 directly dealing with the user/owner of device 12. It is understood that devices 12 maintain the necessary hardware and software for supporting RT 29 as well as for receiving incoming update instructions from PRT 28. Likewise, it is understood that devices 12 are capable of both switching wireless network connectivity arrangements (potentially from network 14 to network 15 as in FIG. 2) as well as switching content programming/skins from one MVNO 16 to the next.

In one embodiment of the present invention, a billing module 30 is provided, coupled to controller 18 and configured to receive input from MVNO module 20, Network module 22, and user profile module 24 in order to collect and track a device's 12 usage so that the appropriate billing issues can be settled with the user, mobile network 14 and MVNOs 16.

For example, in one arrangement of the present invention, a user of device 12 may have a contract for full mobile services from content management platform 10 for mobile wireless minutes and MVNO 16 access. Profile 50 maintains the appropriate contract information about these settings for each particular user of device 12. As the user utilizes airtime/minutes, such data is transmitted from wireless network 14 to network module 22 for appropriate tracking and bill generation by billing module 30. Likewise, MVNO 16 usage may be sent to MVNO module 20 from MVNOs 16 so that billing module may also track this usage by the user.

Such an arrangement for example allows platform 10 to maintain bulk airtime/wireless contracts for all its users for maximum cost reduction, whereby billing module 30 allows platform 10 to allocate the necessary billing down to their individual devices 12 based on their specific airtime usage. By essentially subdividing airtime from bulk contracts improved rates can be achieved with mobile networks 14 the savings of which can either be passed on to users for improved signup rates or improved profit margins. Likewise, billing module 30 keeps the necessary records of device 12 usage of the various MVNOs16 so that appropriate portion of the users' cost for signing up for a particular MVNO 16 may be split between MVNO 16 and platform 10.

In one embodiment of the present invention, an advertising module 32 is configured to push advertisements and related content to devices 12.

In one arrangement advertisements from advertisement module 32 may simply be additional revenue streams associated with pushed audio/visual opening/closing prompts to the user of device 12. In another arrangement, advertisements from advertisement module 32 may include more lengthy audio/visual opening/closing prompts so as to allow users of device 12 to lower their costs for using platform 10 by accepting advertisements for particular preferred advertisers, potentially to the point of receiving free advertisement supported MVNO options. In yet another arrangement, advertisements may be used by platform 10 to allow MVNOs 16 and mobile networks 14 to advertise either to their customers (users of devices 12 who are already signed up) or to cross-advertise to other users on platform 10 that do not already use their services. Such advertisements may be used by platform 10 to offset or in lieu of payment to MVNOs 16 or mobile network 14. Advertisement module 32 may also cross-promote other platform 10 services such as directory assistance services such as those supported by directory assistance module 34.

In one embodiment of the present invention, a directory assistance module 34 is coupled to controller 18 to allow users of devices 12 to obtain directory assistance. It is contemplated that the users of platform 10 may have a soft button or other number that notifies wireless network 14 to direct a call inward to platform 10 for handling by automated/live operator module 26, who retrieves the desired information from DA module 34.

It is contemplated that DA module 34 may either be an internal module within content management platform 10 or may be an independent and separate external module that is linked in some way to controller 18 for accessing by automated/live operator module 26.

In either arrangement DA platform 34 is configured to provide traditional directory assistance for retrieving telephone numbers for the users of devices 12 as well as any other known enhanced directory assistance features including, but not limited to, directions, movie/restaurant reviews/reservations, geographic locations based services, wireless white pages, and any other automated live operator supported information assistance that can be provided to the users of devices 12.

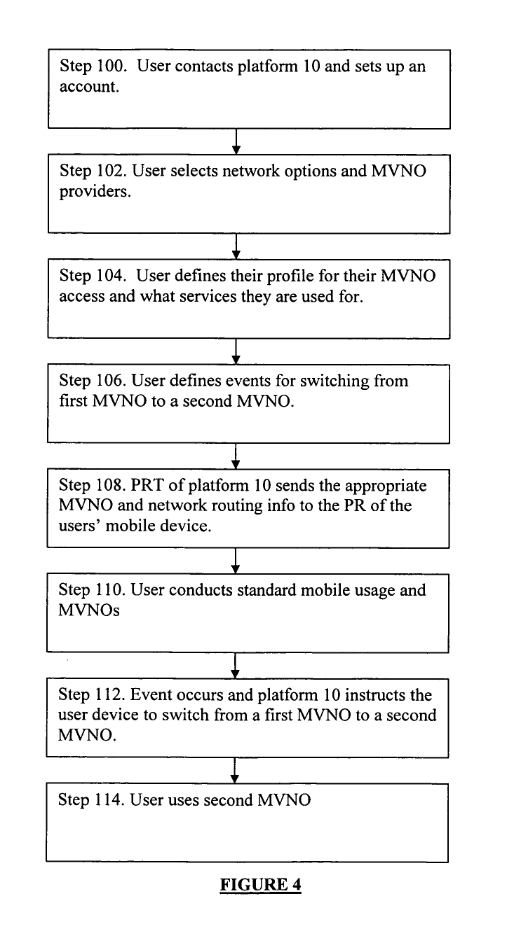

Turning now to the operation, FIG. 4 is a flow chart illustrating the operation of content management platform 12 from the time a user of device 12 signs up through the time of a switching from a first MVNO 16 to a second MVNO 16 occurs. In a first step 100, device 12 contacts content management platform 10 an opens an account. At step 102, the user of device 12, selects some form of wireless account (wireless air time access/$ ? month etc . . . ) and then selects to add one or more MVNOs 16 to their account. It is contemplated that platform 10 maintains a plurality of means for displaying such available MVNOs 16 to the user of device 12 including but not limited to, programmable skin on the mobile device, internet display to the user, direct searchable listing of MVNOs 16 by operator module 26 etc . . .

Next, at step 104, the user further defines which MVNOs 16 are used for what services and times. For example, a single device 12 may sign up for services from six separate MVNOs 16. One MVNO 16 may provide voice mail services, the second on-line search services, the third ringtone downloads, the fourth sports updates, the fifth geographically relevant weather, and the sixth may be a second voice mail service. It is contemplated that any combination of MVNOs 16, and interaction with one another, is within the contemplation of the present invention.

After the initial selection of MVNOs 16 is made at step 104, next, at step 106, the user of device 12 may select certain criteria for which MVNO 16 is functioning on their mobile device as a default as well as other automatic switching to alternative MVNOs based on time of day or other criteria.

For example, the user may select an MVNO 16 for voice mail from 8 am-5 pm and another voice mail MVNO 16 for 5 pm-8 am. In addition to alternate MVNO operators as in the voice mail example, the may select some to run concurrently with the voice mails MVNOs 16 such as to have an MVNO 16 for weather to run from 7 am-9 am (ie. during morning commute hours) and then to switch to sports updates from 9 am-5 pm, both of which would run concurrently with the voice mail MVNOs 16. Once all of the MVNO 16 and all other initial information is set, content management platform 10 stores all of the information in profile 50.

It is contemplated that during this step that platform 10, in the event that multiple mobile networks 14 and 15 in FIG. 2, also makes certain arrangements that govern which mobile network will be used for device 12 and at what times based on the various contracts for mobile coverage used by platform 10. Such criteria for selecting the mobile network 14 or 15 for device 12 to store in profile 50 may include, but is not limited to, primary geographic location of device 12, airtime contract sold to the user of device 12, etc . . .

At a next step 108, the user of device 12 initiates their mobile service with mobile network 14, which contacts controller 18 of content management platform 10. When the user initiates their mobile service on device 12, controller 18, retrieves profile 50, cross-references the information against mobile network module 22, MVNO module 20 and PRT 28 and instructs PRT 28 to send the necessary routing information to RT 29 in mobile device 12 so that their device includes the necessary information to instruct mobile network 14 to send/receive the appropriate MVNO content from MVNOs 16 as identified in profile 50. At step 110, the user may conduct their normal mobile activity including using the MVNO 16 services to which they have subscribed.

At step 112 an event occurs which instructs PRT 28 to send updated routing information to RT 29 so that device 12 is shifted to a second MVNO 16 for a different service. Such an event may either be simply a time/alarm which lets platform 10 known that it time to change MVNOs 16 for a particular user, such as in the current example 5:00 pm when the user has requested that their mobile device 12 be switched from a first voice mail service to a second voice mail service. Alternatively, the event may be user initiated by contacting platform 10 where automated/live operator terminal 26 receives an a direct instruction from device 12 to institute a change to their MVNO 16 service with a corresponding change to their profile 50.

Finally, at step 114, the user continues use of their mobile device 12 now employing the second MVNO 16 until another event occurs at which point step 112 is repeated.

Thus, by the above described arrangement, a user may generate an account with content management platform 10, select a plurality of MVNOs 16 from which they desire some form of mobile content, select an arrangement for switching between the MVNOs 16, whereby platform 10 interacts with the routing table 29 in the user's device 12 to affects such a schedule for using there MVNOs 16. It is understood that the above described series of steps for operating platform 10 is intended as only an exemplary list of steps. Steps may be added, combined, or removed provided the operation is consistent with providing the salient features of the present invention.

In one embodiment of the present invention, an alternate arrangement for content management platform 10 is shown that allows for user context to be tracked, and used to trigger an MVNO 16 switching event.

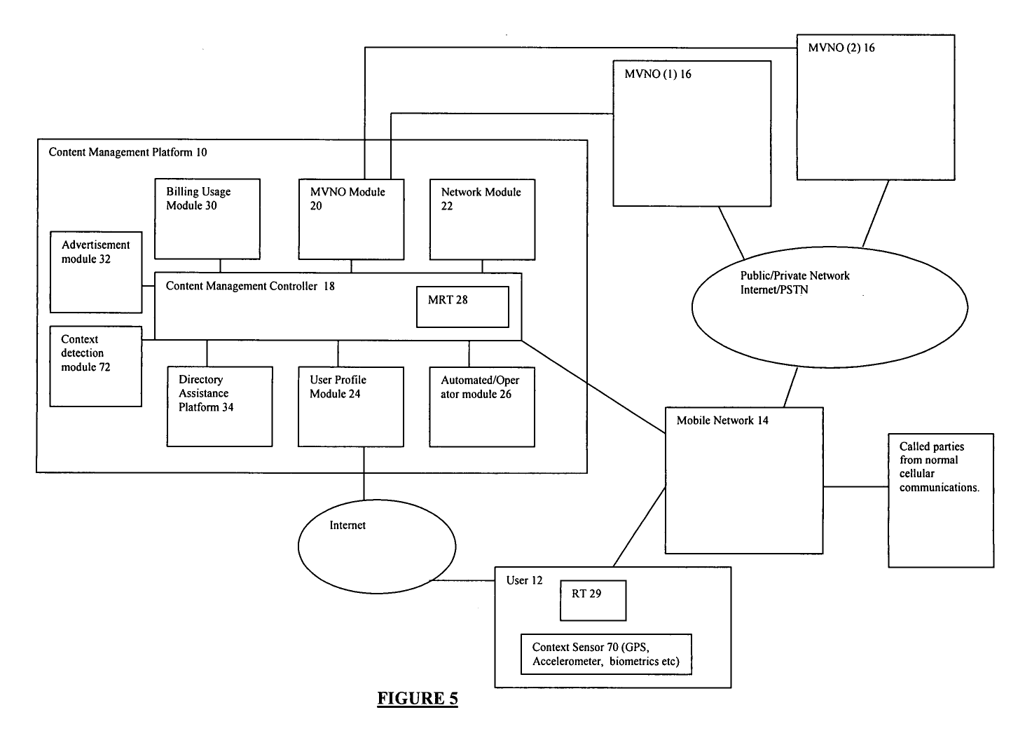

As shown in FIG. 5, device 12 may further include a series of context sensing devices 70. Such sensing devices 70 may include but are not limited to, GPS/location detection equipment, accelerometer, biometrics (pulse detector, eye/retina scan, voice detection etc . . . ), weather detection equipment, etc . . . Likewise, platform 10 further maintains a coupled context detection module 72, attached to controller 18 for receiving information from the sensing device 70 in mobile device 12.

In this arrangement content management platform 10 is now capable of tracing certain contextual information which can be used for advertisement placement from advertisement module 32 or may also be used for a triggering event to switch from a first MVNO 16 to a second MVNO 16.

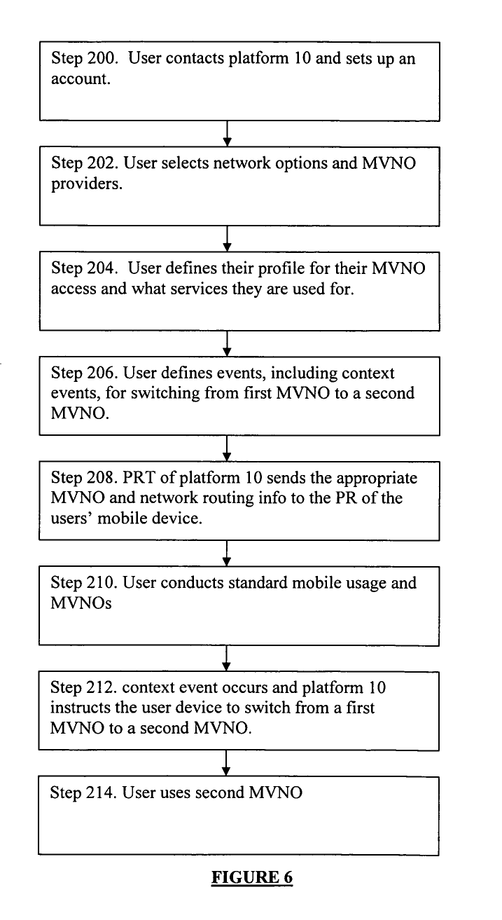

For example, flow chart FIG. 6 is an exemplary flowchart for a user singing up with platform 10, selecting MVNOs 16 and then changing from a first MVNO 16 to a second MVNO 16 upon the detection or occurrence of an event. (Steps 100-114 are substantially equivalent to steps 200-214 except as described below).

At step 206, where the user of device 12 is defining the events to be stored in profile 50 that will trigger the change from a first MVNO 16 to a second MVNO 16, the user may in addition to selecting times, further select a contextual event trigger.

For example, the user may maintain an MVNO 16 for weather related services and a second MVNO 16 for directions. The user may indicate that the weather service MVNO be employed from 7:00 am-9:00 am or until an acceleration detected an accelerometer in mobile device 12 registers a speed over 10 miles per hour in which case the second directions and traffic services MVNO 16 is to be employed immediately. Such a situation may be useful so that as soon as the user of device 12 enters their car and drives, an accelerometer among sensors 70 sends a signal to context module 72 to trigger the change in MVNOs 16.

A second example may be a request for changes using biometric sensors 70, where a triggering event may be set when the heart rate reaches 90 bpm. Here, a user 12 that frequently exercises may wish for a music services MVNO 16 to be triggered automatically when they begin exercising.

Yet another example, for context switching would be for a user to select an enhanced searching services MVNO 16 when they are shopping, where GPS may detect their presence within a retail establishment to automatically turn on a retailer MVNO 16 and return it to a default (directions, etc . . . ) when they leave.

It is understood that the number of context sensors 70 and potential events that may result in an MVNO 16 change are near limitless. Any such context provoked change from a first MVNO 16 to a second MVNO 16 is within the contemplation of the present invention.

It is noted that step 212 is accordingly modified so that PRT 28 instructs RT 29 to change from a first MVNO 16 to a second MVNO 16 upon not only the information in user profile 50, but also the detection of a context event by context module 72. The remaining steps 200, 202, 204, 208, 210, and 214 are essentially the same as the corresponding steps 100, 102, 104, 108, 110 and 114.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A platform for providing mobile services, said platform comprising:
a network module for communicating with at least one mobile network; and
an MVNO module for communication with at least two MVNO service providers; wherein a user may contact said platform and receive mobile services including MVNO services from at least two different MVNO service providers, said platform configured to store a profile generated by said user for storing events where the occurrence of said event causes said platform to switch said user's MVNO service provider from a first MVNO service provider to a second MVNO service provider.

2. The platform as claimed in claim 1, wherein said network module communicates with two or more mobile networks configured to allow a user's mobile device to be operated from either one of said two or more mobile networks.

3. The platform as claimed in claim 1, further comprising a plurality of MVNO service providers, each of which configured to provide a different content related service to said user.

4. The platform as claimed in claim 3, wherein said plurality of MVNO service providers may run concurrently on a mobile device employed by said user.

5. The platform as claimed in claim 1, wherein said profile is for a mobile device of said user and includes data related to user's personal data, subscribed MVNO service providers and mobile networks.

6. The platform as claimed in claim 1, wherein said event is a particular time of day.

7. The platform as claimed in claim 1, further comprising a primary routing table that contains the instructions necessary for switching a mobile device of a user from said first MVNO service provider to said second MVNO service provider.

8. The platform as claimed in claim 7, wherein primary routing table in said platform instructs a routing table in said mobile device of said user with said instructions necessary for switching a mobile device of a user from said first MVNO service provider to said second MVNO service provider.

9. The platform as claimed in claim 1, further comprising a billing module for tracking a billing said user for the services of said plurality of MVNO service providers.

10. The platform as claimed in claim 1, further comprising an advertisement module configured to provide advertisements to said users.

11. The platform as claimed in claim 10, wherein the advertisements delivered to said user by said advertisement module reduces the costs for said user in using said platform.

12. The platform as claimed in claim 10, wherein the advertisements delivered to said user by said advertisement module are directed to other MVNO service providers supported by said platform.

13. The platform as claimed in claim 1, further comprising a directory assistance module for providing directory assistance services to said user.

14. The platform as claimed in claim 1, further comprising an automated/live operator module for allowing a user to update their profile or to manually change their mobile device from said first MVNO service provider to said second MVNO service provider.

15. The platform as claimed in claim 14, wherein said automated/live operator module is configured to offer a listing of available MVNO service providers to said user.

16. The platform as claimed in claim 1, wherein said MVNO service providers are delivered to said users via said mobile networks, where platform provides to said the mobile connectivity via said mobile network without said MVNO service providers needing to interact with said mobile network.

17. A method for providing mobile services to a user, said method comprising the steps of:
communicating with at least one mobile network via a network module;
communicating with at least two MVNO service providers via an MVNO module;
delivering mobile service including MVNO services from at least two different MVNO service providers to said user;
storing a profile generated by said user; and
storing an event in said profile where the occurrence of said event causes said platform to switch said user's MVNO service provider from a first MVNO service provider to a second MVNO service provider.

18. A platform for providing mobile services, said platform comprising:
a network module for communicating with at least one mobile network;
an MVNO module for communication with at least two MVNO service providers; and
a context module for receiving context information from a mobile device of a user, wherein a user may contact said platform an receive mobile services including MVNO services from at least two different MVNO service providers, said platform configured to store a profile generated by said user for storing events where the occurrence of context event causes said platform to switch said user's MVNO service provider from a first MVNO service provider to a second MVNO service provider.

19. The platform as claimed in claim 18, wherein said user's device includes at least one context sensor for detecting said context event.

20. The platform as claimed in claim 19, wherein said context sensor is selected from the group consisting of auto-location sensors, accelerometers and biometric sensors.

21. The platform as claimed in claim 18, wherein said context event is a change in geographic location.

22. The platform as claimed in claim 18, wherein said context event is a detection in change of speed.

23. The platform as claimed in claim 18, wherein said context event is a detection of a change in a biological condition.

24. A method for providing mobile services to a user, said method comprising the steps of:
communicating with at least one mobile network via a network module;
communicating with at least two MVNO service providers via an MVNO module;
delivering mobile service including MVNO services from at least two different MVNO service providers to said user;
receiving context information from a mobile device of said user;
storing a profile generated by said user; and
storing a context event in said profile where the occurrence of said context event causes said platform to switch said user's MVNO service provider from a first MVNO service provider to a second MVNO service provider.
